(19) United States
(12) Patent Application Publication
(10) Pub. No.: US 2008/0285166 A1
(43) Pub. Date: Nov. 20, 2008

(54) METHOD FOR CONTROLLING DRIVE OF RECORDING MEDIUM

(75) Inventors: TAKASHI KATAGIRI, Yokohama-shi (JP); HIROKAZU NAKAYAMA, Fujisawa-shi (JP)

Correspondence Address: SHIMOKAJI & ASSOCIATES, P.C., 8911 RESEARCH DRIVE, IRVINE, CA, 92618, US

(73) Assignee: INTERNATIONAL BUSINESS MACHINES CORPORATION, Armonk, NY (US)

(21) Appl. No.: 12/180,474

(22) Filed: Jul. 25, 2008

Related U.S. Application Data
(63) Continuation of application No. 11/383,105, filed on May 12, 2006.

(30) Foreign Application Priority Data
May 12, 2005 (JP) 2005-140055

(51) Int. Cl. G11B 5/09

(52) U.S. Cl. 360/47

(57) ABSTRACT

A method of controlling a drive of a recording medium according to one embodiment includes receiving data from a host, and writing the data to the recording medium. A difference in volume between the data at the time of being received from the host and the data at the time of being written to the recording medium is detected. An adjustment is made to at least one of a first transfer rate with the recording medium, and a second transfer rate with the host, based on the difference.

### TECHNICAL FIELD

The present invention relates to a device and the like which control the drive of a recording medium such as a magnetic tape, and more particularly relates to a device and the like which is capable of adjusting a transfer rate in between with an upper device and a transfer rate in between with a recording medium.

### BACKGROUND ART

Writing data to a tape medium such as a magnetic tape, and reading data from the tape medium, is performed by causing a recording head to move relative to the tape medium. Therefore, if the tape medium is caused to be run at a higher speed, it is possible to transfer the same amount of data between the recording head and the tape medium in a shorter time. That is, the transfer rate (a write rate and a read rate) in between the head and the tape medium increases if the running speed of the tape medium is high, and decreases if the running speed thereof is low. Hence, if the tape medium is made to run at as high a speed as possible, the transfer rate in between the head and the tape medium increases, and it is expected that an efficient data transfer can be performed.

However, on the contrary, when the tape medium is made to run at an unnecessarily high speed, it is impossible to perform a data transfer efficiently. When a transfer rate in between the drive containing the head and a host computer (hereinafter, referred to as the host) is lower than the transfer rate in between the drive and the tape medium, a back hitch is triggered. The back hitch is an operation that reduces the running speed of the tape medium and then halts it once in order to move back to a position to be written, for the purpose of writing the next set of data into the position where the data on the tape medium is continuous, e.g., in a case where there is not sufficient data to be written to the tape medium. It normally requires approximately three seconds for the back hitch. Although data is being sent during this back hitch, the data is not written to the tape medium. That is, if it is not possible to continue receiving data from the host for three seconds, the performance of transferring data to the tape medium degrades significantly. Although the data sent from the host is normally stored in a buffer, when the size of the buffer is small, such degradation in the performance can be seen more clearly. In addition, it is also desirable to reduce the back hitch as much as possible from the viewpoint of a load on the tape medium.

On the other hand, inconvenience is caused when a tape medium is made to be run at a low speed. If the transfer rate in between the drive and the tape medium is lower than the transfer rate in between the drive and the host, data waiting to be written to the tape medium accumulates in the buffer. As a result, the substantial transfer rate in between the drive and the host is made lower. Consequently, when the data sent from the host is being written to the tape medium or the data read from the tape medium is being sent to the host, it can be said that it is preferable that the transfer rate in between the drive and the host matches the transfer rate in between the drive and the tape medium.

Therefore, a tape medium has conventionally been controlled in a manner that causes tape medium to run at a speed appropriate for the transfer rate of a host. For example, if the transfer rate with the host is 40 MB/sec, the tape medium is caused to run at 2.73 m/sec. If the transfer rate with the host is 50 MB/sec, the tape medium is caused to run at 3.41 m/sec. Such control functions effectively, if the volume of data is unchanged in a case where the data sent from the host is written to the tape medium. However, if the volumes are different at the time of being sent from the host and the time of being actually written to the tape medium, the control does not function effectively.

This matter will be explained, using an example of a linear tape-open (LTO) format. LTO is an open standard which was developed in cooperation with three companies: IBM, Hewlett-Packard and Quantum. In LTO, a plurality of codeword quads (CQs) compose a CQ set, and the writing is performed by using a data set comprised of a plurality of CQ sets as a unit. At this point, the writing is performed while reading data written on-the-fly and verifying whether or not the data has been written correctly (Read-While-Write). Here, when even one CQ included in a CQ set, which should have been written, cannot be read, the CQ set is allowed to be rewritten (CQ rewrite).

Accordingly, the number of CQ sets included in a data set which has actually been written to a tape medium may be variable, and the size of the data set may be different (the number of CQ rewrites is, 0 at the minimum and 256 at the maximum in a case of LTO Generation 3, and 0 at the minimum and 128 at the maximum in a case of LTO Generations 1 and 2).

Incidentally, as conventional technologies, proposed are a technology of reducing a data transfer speed in a case where a command from a host is a retry command (for example, Japanese Patent Application Laid-open No. Hei 11-249821) and a technology of reducing a tape speed upon retrying to read data from a recording medium compared with a speed upon recording (for example, Japanese Patent Application Laid-open No.

However, the objects of these conventional technologies are not to match a transfer rate in between the drive and a host and in between the drive and a tape medium. That is, when errors are caused, the transfer rate in between the drive and the host and in between the drive and the tape medium are merely adjusted individually. Therefore, in a case described above where the size of a data set sent from the host due to the occurrence of CQ rewrite in LTO was different from the size of a data set actually written to the tape medium, the problem that it is not possible to efficiently write to the tape medium remains.

### SUMMARY OF THE INVENTION

A method of controlling a drive of a recording medium according to one embodiment includes receiving data from a host, and writing the data to the recording medium. A difference in volume between the data at the time of being received from the host and the data at the time of being written to the recording medium is detected. An adjustment is made to at least one of a first transfer rate with the recording medium, and a second transfer rate with the host, based on the difference.

A method of controlling a drive of a recording medium according to another embodiment includes reading data from the recording medium and detecting a difference in volume between the data recorded on the recording medium and the data at the time of being received from a host computer for recording on the recording medium. An adjustment is made to at least one of a first transfer rate with the recording medium and a second transfer rate with the host computer.

A computer program product comprising a computer useable medium including a computer readable program executable on a computer, causing the computer to perform the methods disclosed herein.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a block diagram showing a computer system in an embodiment of the present invention.

FIG. 2 is a block diagram showing a functional configuration of a controller in one embodiment of the present invention.

FIG. 3 is a flow chart showing the operations of a transfer rate acquisition unit in one embodiment of the present invention.

FIG. 4 is a flow chart showing the operations of an error rate acquisition unit in one embodiment of the present invention.

FIG. 5 is a flow chart showing the operations of a speed determination unit in one embodiment of the present invention.

FIG. 6 is a view showing an example of the contents of a corresponding table referred to by the speed determination unit in one embodiment of the present invention.

FIG. 7 is a view graphically illustrating CQ rewrite in one embodiment of the present invention.

### BEST MODE FOR CARRYING OUT THE INVENTION

The following description is the best mode presently contemplated for carrying out the present invention. This description is made for the purpose of illustrating the general principles of the present invention and is not meant to limit the inventive concepts claimed herein. Further, particular features described herein can be used in combination with other described features in each of the various possible combinations and permutations.

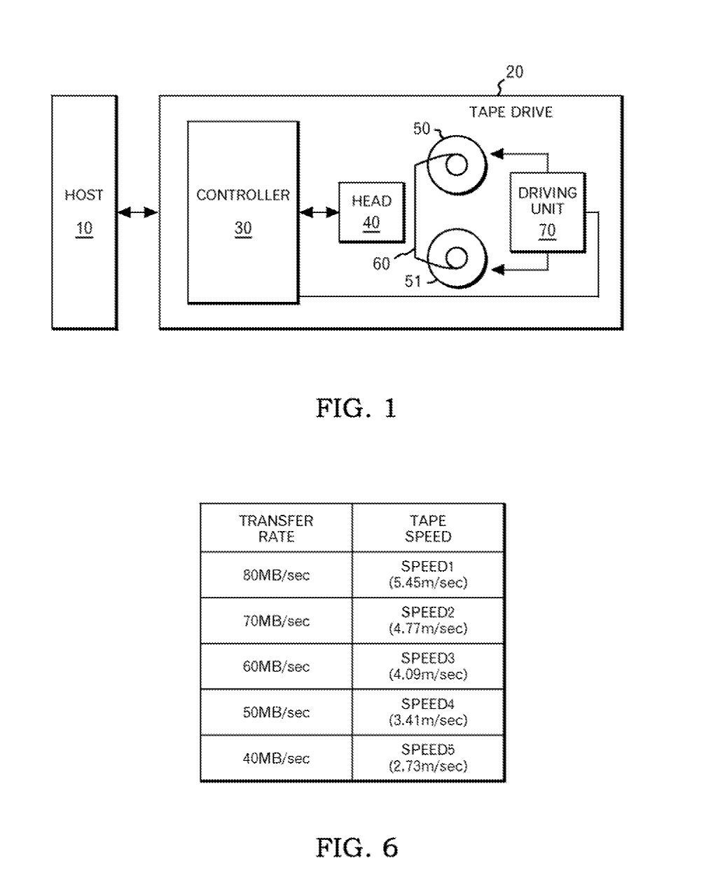

FIG. 1 is a view showing a configuration of a computer system to which the various embodiments of the present invention may be applied. This computer system is configured as a host 10 and a tape drive 20.

The host 10 may be a general computer such as a personal computer. In one embodiment, the host 10 includes: a Central Processing Unit (CPU) controlling the operations of a whole computer; and a main memory storing a program and a data, which are directly accessed by the CPU. In addition, the host 10 may include: an input device for inputting a command and data of a process, such as a keyboard and a mouse; and an output device for displaying a process result, such as a display.

The tape drive 20 includes a controller 30, a head 40, and reels 50 and 51. Moreover, a tape 60 in a cassette or on spools may be operatively wound around and extend between the reels 50 and 51. The tape drive 20 further includes a driving unit 70 for controlling the rotation of the reels 50 and 51.

The head 40 is a mechanism to write data to the tape 60 and read data from the tape 60. Additionally, in this embodiment, the tape drive 20 is assumed to perform an operation in conformity with LTO, and the head 40 is capable of read data after writing the data (read while write).

The reels 50 and 51 are mechanisms to move the tape 60 in a direction from the reels 50 to 51 or from the reels 51 to 50, by rotating. The driving unit 70 controls the rotation of the reel 50 and/or the reel 51.

The controller 30 controls writing data to the tape 60 and reading data from the tape 60 in accordance with a command from the host 10. In addition to this, the controller 30 controls the running speed of the tape 60 by controlling the rotation speed of the reel 50 and/or 51 in the embodiment. Incidentally, the tape drive 20 may also include a CPU and a main memory, similarly to the host 10, in order to realize the controller 30.

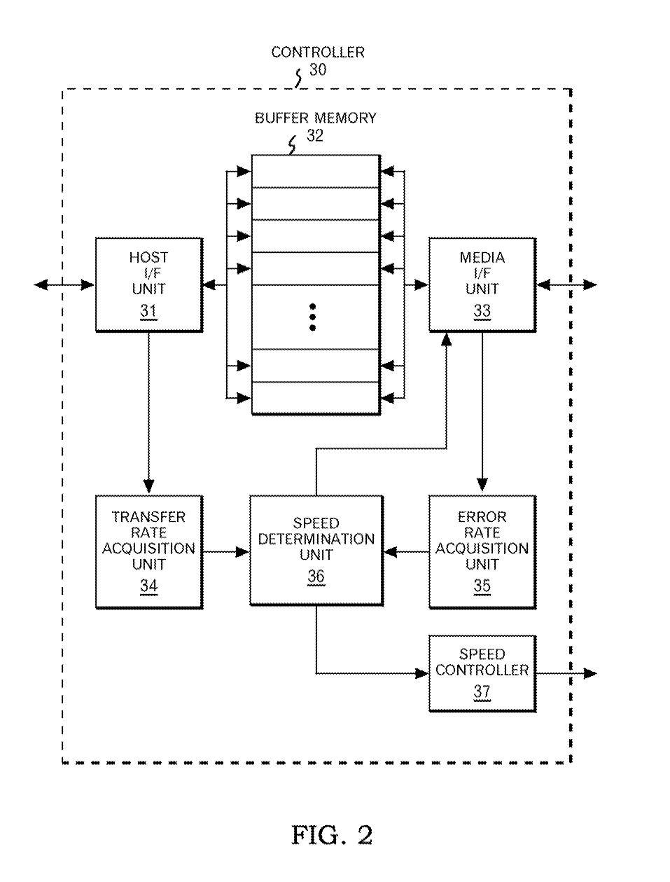

FIG. 2 is a view showing the functional configuration of an illustrative controller 30 in one embodiment of the present invention. This controller 30 includes a host interface unit (hereinafter, referred to as a “host I/F unit”) 31, a buffer memory 32, and a media interface unit (hereinafter, referred to as a “media I/F unit”) 33. Moreover, the controller 30 further includes a transfer rate acquisition unit 34, an error rate acquisition unit 35, a speed determination unit 36 and a speed controller 37.

With continued reference to FIGS. 1 and 2, the host I/F unit 31 receives a data set to be written into the tape 60 from the host 10 to store in the buffer memory 32, and fetch the data set stored in the buffer memory 32 to send to the host 10. In addition, the buffer memory 32 has a volume which can store a plurality of data sets.

The media I/F unit 33 fetches the data stored in the buffer memory 32 and transfers the data to the head 40 for recording on the tape 60. Additionally, the media I/F unit 33 receives the data set recorded on the tape 60 and read by the head 40 for storage in the buffer memory 32. Moreover, whether or not the writing is performed correctly may be verified in LTO by reading a CQ set once after writing the CQ set. Such verification is also performed at the media I/F unit 33.

The transfer rate acquisition unit 34 receives, from the host I/F unit 31, information on a volume of a data set sent and received between the host 10 and the tape drive 20, and acquires a transfer rate.

The error rate acquisition unit 35 receives, from the media I/F unit 33, information on CQ rewrite upon writing the data set to the tape 60, and acquires an error rate.

The speed determination unit 36 determines the speed of the tape 60, based on the transfer rate acquired by the transfer rate acquisition unit 34 and the error rate acquired by the error rate acquisition unit 35.

The speed controller 37 controls the driving unit 70 so that the tape 60 runs at the determined speed.

Meanwhile, among these functions, the media I/F unit 33 and/or the error rate acquisition unit 35 function as a detector for detecting a difference (for example, the number of times of CQ rewrite) between the volume of data recorded on the tape and the volume of data at the time of data being sent to and received from the host 10. Moreover, based on the difference detected, the speed determination unit 36 and/or the speed controller 37 function as an adjuster for adjusting a transfer rate of the drive 20 with the host 10 and a transfer rate of the drive 20 with the tape 60.

Incidentally, each of these functions may be realized by the cooperation of software and hardware resources. Specifically, they may be realized by causing the CPU of the tape drive 20 to read a program which realizes each function of the host I/F unit 31, the media I/F unit 33, the transfer rate acquisition unit 34, the error rate acquisition unit 35, the speed determination unit 36 and the speed controller 37, into the main memory from an unillustrated magnetic disk device or the like.

Next, detailed descriptions will be given of the operation of the controller 30.

First, a description will be given of the operation of the controller 30 during writing a data set sent from the host 10 to the tape 60. When a data set is sent from the host 10, the host I/F unit 31 receives this data set and stores it in the buffer memory 32. In this case, a unit of data received from the host 10 is not necessarily a data set. For example, a unit of data from the host 10 may be a record, and a plurality of records may compose one data set. Furthermore, as illustrated, the buffer memory 32 is assumed to be divided into a plurality of partitions to store one data set in one partition.

When the host I/F unit 31 stores the data set in the buffer memory 32 in this manner, the transfer rate acquisition unit 34 acquires a transfer rate with the host 10.

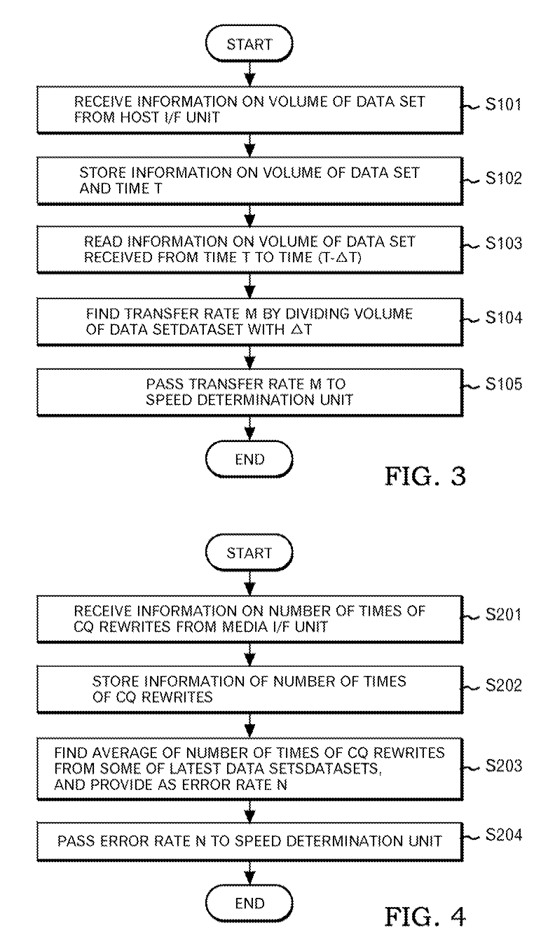

FIG. 3 is a flow chart showing the operation of the transfer rate acquisition unit 34.

With reference to FIGS. 1-3, the transfer rate acquisition unit 34 receives, from the host I/F unit 31, information on the volume of the data set communicated between the host 10 and the tape drive 20 in Step S101.

Then, the information on the volume of the received data set and information at a time T when the information was received, is stored in Step S102.

The transfer rate acquisition unit 34 accumulates the information on the volumes of the data sets which have so far been received and the information of the times when those data sets were received. Consequently, information on the volumes of the data sets which have been received from the time (T-ΔT) to the time T is read from these pieces of information in Step S103. A transfer rate M is then found by dividing the volumes of the read data sets by ΔT in Step S104. Thereafter, the transfer rate M is passed to the speed determination unit 36 in Step S105.

As the above-described operation related to the acquisition of the transfer rate is just an example, the operations can be performed in any process. For example, a method in which the transfer rate acquisition unit 34 refers to the buffer memory 32 at regular intervals and then a transfer rate is found by recognizing newly added data, can be considered.

In addition, the data set stored in the buffer memory 32 is fetched by the media I/F unit 33 at certain timing, and the data set is sent to the head 40 to be written to the tape 60. At this point, as described above, in LTO, the form of verifying whether or not a CQ set has been written correctly by reading it out again after writing it to the tape 60 may be adopted. As a result of the verification, if any CQ included in the CQ set has not been written correctly, CQ rewrite for rewriting the CQ set is performed. Depending on the number of times of CQ rewrites whether it is large or small, the relative sizes between a data set sent from the host 10 and the data set actually written to the tape 60 may be different. Therefore, the error rate acquisition unit 35 acquires a ratio of CQ rewrite occurrences (an error rate), which is reflected in a determination of the tape speed.

FIG. 4 is a flow chart showing the operations of the error rate acquisition unit 35.

Referring to FIGS. 1, 2 and 4, the error rate acquisition unit 35 receives, from the media I/F unit 33, information of the number of occurrences of CQ rewrites for each data set, for example, in Step S201. The received information on the number of times of CQ rewrites is stored in Step S202.

The error rate acquisition unit 35 accumulates pieces of the information so far received on the number of CQ rewrites. From these pieces of the information, the average of the number of CQ rewrites is found regarding some of the latest data sets in order to set the average as an error rate N in Step S203. Subsequently, the error rate acquisition unit 35 passes the error rate N to the speed determination unit 36 in Step S204.

It should be apparent that the above-described operations related to the acquisition of the error rate is just an example, and the operations can be performed in any process. Although the number of CQ rewrites for each data set is used here, the number of CQ rewrites for each unit time can be used, for example. Moreover, a method of not counting the number of CQ rewrites but measuring time required to write one data set can be considered. When a CQ rewrite takes place, it takes a longer time to write one data set. Hence, even if the number of CQ rewrites is not counted directly, it is possible to obtain a similar effect by measuring this time.

When the transfer rate M is passed from the transfer rate acquisition unit 34 and the error rate N is passed from the error rate acquisition unit 35 in this manner, the speed determination unit 36 determines the speed of the tape 60 by use of these pieces of the information.

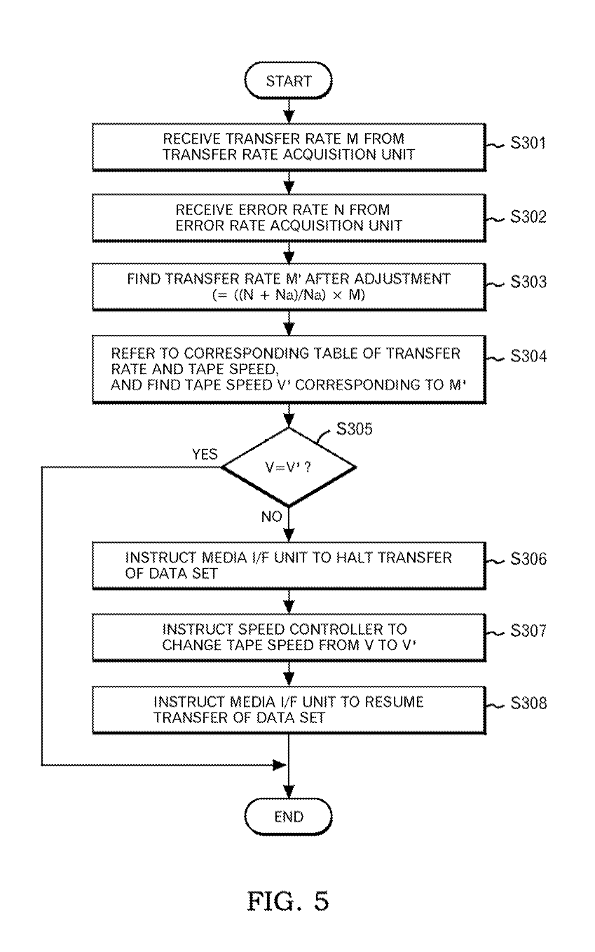

FIG. 5 is a flow chart showing the operations of the speed determination unit 36.

Referring to FIGS. 1, 2 and 5, the speed determination unit 36 receives the transfer rate M from the transfer rate acquisition unit 34 in Step S301, and receives the error rate N from the error rate acquisition unit 35 in Step S302.

Here, assuming that the number of CQ sets originally included in one data set is Na and that CQ rewrites take place N times for one data set, the number of CQ rewrites included in the data set written to the tape 60 is (N+Na). Accordingly, the transfer rate from the host 10 is M, but the number of CQ sets actually written is ((N+Na)/Na) times. Hence, the transfer rate in between with the tape 60 is required to be (M×(N+Na)/Na). In other words, setting the transfer rate in between with the tape 60 to (M×(N+Na)/Na) leads to catching up with a transfer rate M with the host 10. That is, the speed determination unit 36 finds a transfer rate M′ after adjustment, derived from “M′=M×(N+Na)/Na” in Step 303.

Then, the speed determination unit 36 refers to a corresponding table which defines correspondence between a transfer rate and a tape speed, and finds a tape speed V′ corresponding to the transfer rate M′ after adjustment in Step 304.

FIG. 6 is an example of a corresponding table which may be referred to by the speed determination unit at this point. Meanwhile, this corresponding table is an example of the case of LTO Generation 3. If LTO generation changes, a format, namely, the recording density of data recorded on a tape also changes. Therefore, a tape speed is also made to correspond to a different speed.

In this embodiment, the transfer rates with the host 10 are provided while being separated into five stages. Specifically, the five stages are 80 MB/sec, 70 MB/sec, 60 MB/sec, 50 MB/sec and 40 MB/sec. In addition, the table defines that the tape speeds of 5.45 m/sec, 4.77 m/sec, 4.09 m/sec, 3.41 m/sec and 2.73 m/sec are appropriate for the respective transfer rates. In descriptions below, “SpeedX” (X=1, . . . , 5) is assumed to represent the tape speed instead of a specific number.

Furthermore, although the transfer rates are separated into the five stages in the drawing, they may be separated into fewer or more stages than this.

Now, returning to FIG. 5, the descriptions of the operations of the speed determination unit 36 will be continued. When the tape speed V′ is found in Step S304, the speed determination unit 36 judges whether or not an original tape speed V is equal to the tape speed V′ after adjustment in Step S305). If they are equal, the process is ended without performing anything.

On the other hand, if they are not equal, a process to change the tape speed is performed. In this embodiment, a data transfer is halted once during the change of the tape speed. Therefore, the speed determination unit 36 commands the media I/F unit 33 to halt the transfer of a data set in Step S306. Thereafter, the speed determination unit 36 commands the speed controller 37 to change the tape speeds from V to V′. Hence, the command from the speed controller 37 is conveyed to the driving unit 70. Consequently, the driving unit 70 changes the tape speeds by controlling the reel 51 or 52 in Step S307. Upon completing the change of the tape speed, the speed determination unit 36 commands the media I/F unit 33 to resume the transfer of the data set in Step S308.

Next, with reference to a corresponding table in FIG. 6, specific descriptions will be given of the determination of the tape speed in Step S304. Here, the number Na of CQ sets included in one data set is 128, taking LTO Generation 3 as an example.

First, assumed is Speed5 which is defined in the corresponding table that the transfer rate M is 40 MB/sec. In this case, if the error rate N is 128, the transfer rate M′ after adjustment is 80 MB/sec, which is derived from “140×(128+128)/128=80”. With reference to the corresponding table, the tape speed V′, which is appropriate to 80 MB/sec, is Speed1. Therefore, the tape speed is changed to Speed1. In this case, it is possible to obtain approximately twice (=5.45/2.73) the transfer efficiency due to the change of the tape speed from Speed5 to Speed1.

Moreover, the tape speed is similarly changed also in a case of Speed3 which is defined that the transfer rate M is 60 MB/sec. In this case, if the error rate N is assumed to be 128, the transfer rate M′ after adjustment is 120 MB/sec, which is derived from “60×(128+128)/128=120”. Since 120 MB/sec is not defined when referring to the corresponding table, 80 MB/sec which is the maximum transfer rate may be selected. The tape speed V′ appropriate to 80 MB/sec is Speed1. Hence, the tape speed is changed to Speed1. In this case, it is possible to obtain approximately 1.3 times (=5.45/4.09) transfer efficiency due to the change from Speed3 to Speed1.

In this manner, although the widths of the effects are different, it is possible to improve the efficiency of a data transfer to the tape 60 by setting the speed of the tape 60 to Speed1 in a case where the tape 60 is running at Speed2 to Speed4.

On the other hand, when the tape 60 is running at Speed1 from the beginning, the transfer efficiency does not improve. However, when the tape 60 is made to run at an unnecessarily high speed, a back hitch is caused. For this reason, in this embodiment, even if the tape speed is first set to high, when the error rate is made to be small after that, the tape speed is controlled to be low (if N equals 0 in Step S303, M′ equals M). Therefore, when considering a certain point of time, there is a high possibility that the tape 60 is not running at Speed1. Consequently, improvement in the efficiency of a data transfer can be seen in most cases.

Next, descriptions will be given of the operations of the controller 30 at the point when the data set passed from the head 40 is sent to the host 10. With continued reference to FIGS. 1 and 2, when the data set is passed from the head 40, the media I/F unit 33 receives the data set and stores it in the buffer memory 32. Additionally, information on the number of CQ rewrites that have taken place during the writing is added to the data set as header information. Therefore, the number of CQ rewrites for one data set is shown. Thus, the error rate acquisition unit 35 acquires a ratio of occurrences of CQ rewrites for one data set (the error rate) and reflects it on the determination of a tape speed. Moreover, as described above, the buffer memory 32 is assumed to be divided into 128 partitions, and each CQ set is assumed to be stored in each partition, for example. Here, a CQ is read in the order it was written and then is stored in the buffer memory 32. Hence, with regard to CQs where CQ rewrite has taken place, the CQs which have not been written correctly are first read and are stored in the buffer memory 32. Thereafter, the CQs are overwritten with CQs which are correctly written.

The descriptions of the operations of the error rate acquisition unit 35 here will be omitted since the operations are the same as those already described with reference to FIG. 4.

Furthermore, the data set stored in the buffer memory 32 is fetched by the host I/F unit 31 at a certain timing and is sent to the host 10. When the data is sent by the host I/F unit 31 in such a manner, the transfer rate acquisition unit 34 acquires a transfer rate.

Incidentally, the descriptions of the operations of the transfer rate acquisition unit 34 here will be omitted since the operations are the same as those already described with reference to FIG. 3.

Thereafter, the speed determination unit 36 determines a tape speed based on the operations similar to those already mentioned with reference to FIG. 5, and commands the speed controller 37 to change the tape speed. As a result, the command from the speed controller 37 is conveyed to the driving unit 70 and the driving unit 70 changes the tape speed by controlling the reels 50 and 51.

As described above, the operations of the embodiment is ended.

In this embodiment, a tape speed is determined not only with a transfer rate on the host side, but also considering error information on the recording medium. For this reason, even when data transfer is slower due to the occurrence of an error on the recording medium side, it is possible to transfer data efficiently.

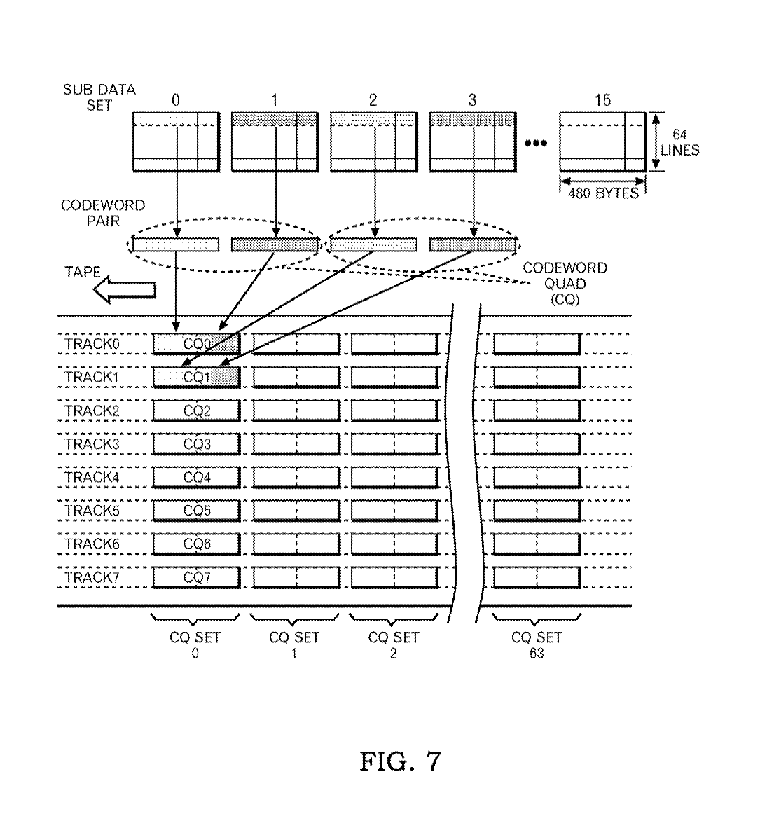

Next, descriptions will be given of an error example in which adopting the embodiments is effective, with reference to FIG. 7.

FIG. 7 is a view showing a tape format of LTO Generations 2 and 1.

First, a data set is divided into sub data sets 0, 1, . . . , 15. Each sub data set contains 64 lines and each line is 480 bytes. Moreover, the 2×i-th codeword quad (CQ) is created from the first line of the i-th sub data set and the first line of the (2×i+1)-th sub data set. Furthermore, the i-th CQ is written to the i-th track (i=0, 1, . . . , 7). A set of eight CQs written in this manner is a CQ set 0. This is repeated for 64 lines. Consequently, CQ sets 0, 1, . . . , 63 are written on the tape 60. Please note that in Generation 3, there are 64 sub data sets and 128 CQ sets.

Suppose something unusual occurs in the head for writing on the track 0. Since the CQ 0 has not been written correctly in the CQ set 0, the CQ set 0is rewritten after rotation of the CQ 0 to another track where it is possible to write correctly in the head. Therefore, the writing of the CQ 0 is completed since the CQ 0 is written correctly. If unusual things continuously occur in the head for writing on the track 0 even after that, CQ rewrite is performed once for each of the CQ sets 0 to 63 in the end. Consequently, the number of the CQ sets included in the data set comes to be twice the number of the CQ sets included in the data set sent from the host 10. If the method of this embodiment is adopted in such a case, it may be possible to transfer data without causing the host 10 to wait.

Since a tape drive which does not support writing during the adjustment of a tape speed is set as a premise in the embodiment, the data transfer is caused to temporarily halt during the change of a speed. However, this will depend on the hardware mechanism of a tape drive. If it is a tape drive which supports writing during a change of tape speed, it is possible to change the tape speed while transferring data. In the case of using such a hardware mechanism, the processes of Steps S306 and S308 in FIG. 5 may not be performed. In addition, the halt of a data transfer in the embodiment is merely a temporary one. Thus, when errors happen continuously, a change in tape speed leads to improvement in a transfer rate on a long-term basis.

Moreover, although a tape medium is exemplified as a recording medium in the embodiment, it is possible to apply the teachings herein to storage systems implementing a disk medium. In this case, the rotation speed of the disk medium is determined, based on a transfer rate on a host side and an error rate on a recording medium.

Furthermore, CQ rewrite is assumed as an example of an error rate in the embodiment. However, the present invention is effective also in cases where there is a difference caused by another error in data size between a time of transfer and that of recording. However, the error in this case is not correlated with a change in tape speed, and is one which can enable an error recovery without causing a back hitch (without stopping a tape). Also, when a difference is caused by an error in a time required to transfer data and a time required to write and read data although the data volume is unchanged, it is possible to employ embodiments of the present invention for adjusting a transfer rate and a write/read rate.

Moreover, as described above, the descriptions have been given on the premise that the data volume actually written to a recording medium is larger than the data volume sent from a host, similarly to CQ rewrite in LTO. However, the present invention is not necessarily limited to such relation of the size. In other words, it does not matter if it is a mode where a transfer rate on the host side is caused to match a transfer rate on the recording medium side when the data volume sent from the host is larger than the data volume written to the recording medium.

Furthermore, there is no problem if the transfer rate on the host side is caused to match the transfer rate on the recording medium side or the transfer rate on the recording medium side is caused to match the transfer rate on the host side, as long as both of these transfer rates are adjusted in a way that causes them to come close to each other in the end.

Additionally, the transfer rates to be adjusted here are not limited to a configuration that one transfer rate is between the host and a buffer memory and the other is between the buffer memory and the recording memory.

For example, when a compressor is provided between the host and the buffer memory, the transfer rate may be between the compressor and the buffer memory. In this case, upon writing data, the transfer rates when compressed data is written to the buffer memory is adjusted to match the transfer rate when the compressed data is fetched from the buffer memory and then is written to the recording medium. In addition, upon reading data, the transfer rate when reading data from the recording medium to the buffer memory is adjusted to match the transfer rate when data (before decompression) is read by the compressor.

Furthermore, when a plurality of buffer memories are provided between the host and the recording medium, one or both of the transfer rates targeted for adjustment may be rate(s) between the buffer memories. For example, data sent from the host is assumed to be written to the recording medium via a buffer A, a buffer B and a buffer C in the order mentioned. In this case, when the transfer rate is changed before and after the buffer B for some reason, it is possible to utilize an embodiment of the present invention in order to cause the transfer rate between the buffers A and B to match the transfer rate between the buffers B and C.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Computer program products comprising a computer useable medium including a computer readable program, wherein the computer readable program when executed on a computer causes the computer to perform any combination of the steps or operations described herein are also considered to be within the scope of the present invention. For example, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1-17. (canceled)

18. A method for controlling driving of a recording medium, comprising:
a step of receiving data from a host computer;
a step of writing the data to the recording medium;
a step of receiving a proportion wherein redundancy occurs in a part of data that is recorded on the recording medium occurs, at the point in time of the reception from the host computer, in the data at the point in time of actually writing to the recording medium; and
an adjusting step for performing adjustments of a first transfer rate, which is the volume of data that is actually written to the recording medium within a predetermined time interval, based on a proportion and on a second transfer rate, which is the volume of data that is actually exchanged with the host computer during the predetermined time interval; wherein
the adjusting step increases the speed of travel or of rotation of the recording medium when the first transfer rate should be increased when the proportion has increased.

19. The method according to claim 18, wherein, in the receiving step, the proportion is received based on a volume of data at a point in time of receiving from the host computer and a volume of data at a point in time of actually writing to the recording medium.

20. A method for controlling driving of a recording medium, comprising:
a step of reading out data from a recording medium;
a step of receiving a proportion wherein redundancy occurs in a part of data that is written to the recording medium occurs, at the point in time of the reception from the host computer for recording on the recording medium, based on additional information of the data; and
an adjusting step for performing adjustments of a first transfer rate, which is the volume of data that is actually read from the recording medium within a predetermined time interval, based on a proportion and on a second transfer rate, which is the volume of data that is actually exchanged with the host computer during the predetermined time interval; wherein
the adjusting step increases the speed of travel or of rotation of the recording medium when the first transfer rate should be increased when the proportion has increased.

21. The method according to claim 20, wherein, in the receiving step, the proportion is received based on the volume of data that is actually written to the recording medium and a volume of data at a point in time of receiving from the host computer for writing to the recording medium.
